(19) United States
(12) Patent Application Publication
(10) Pub. No.: US 2010/0201917 A1
(43) Pub. Date: Aug. 12, 2010

(54) LIQUID CRYSTAL DISPLAY DEVICE AND METHOD FOR FABRICATING THE SAME

(75) Inventors: Sun-Hwa LEE, Gyeonggi-do (KR); Moon-Sik KANG, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG DISPLAY CO., LTD., Seoul (KR)

(21) Appl. No.: 12/644,692

(22) Filed: Dec. 22, 2009

(30) Foreign Application Priority Data
Feb. 11, 2009 (KR) 10-2009-0010927

(51) Int. Cl. G02F 1/13357; G02F 1/1335; G02F 1/13

(52) U.S. Cl. 349/65; 349/69; 349/187

(57) ABSTRACT

Disclosed are a liquid crystal display device including LED local blocks commonly applicable to liquid crystal display panels having different sizes, regardless of model sizes of liquid crystal display device, and a method for fabricating the same.

The liquid crystal display device includes a liquid crystal display panel; and a back light unit comprising a plurality of LED local blocks arranged in a matrix, each having a same.

This application claims the benefit of Korean Patent Application No. 10-2009-0010927, filed on Feb. 11, 2009, which is hereby incorporated by reference as if fully set forth herein.

### BACKGROUND OF THE INVENTION

1. Field of the Invention

The present invention relates to a liquid crystal display device. More specifically, the present invention relates to a liquid crystal display device comprising a plurality of LED local blocks commonly applicable to liquid crystal display panels having different sizes, regardless of model sizes of liquid crystal display panels.

2. Discussion of the Related Art

In accordance with information-oriented society, devices to display information are being actively developed. Display devices include liquid crystal display devices, organic electro-luminescence display devices, plasma display panels and field-emission display devices.

Of these, liquid crystal display devices are utilized in applications including mobile phones, navigators, monitors and televisions, since they have advantages of low weight, low power consumption and full-color image representation. Such a liquid crystal display device cannot self-emit light and thus comprises back light units to supply light to liquid crystal display panels.

Back light units for liquid crystal display devices generally utilize cylindrical fluorescent lamps such as cold cathode fluorescent lamps (CCFLs), hot cathode fluorescent lamps (FCFLs), external electrode fluorescent lamps (EEFLs), light emitting diode (LED) devices and electro-luminescent (EL) devices. Depending on the arrangement type of light sources, back light units are classified into edge-type back light units and direct-type back light units.

The edge-type back light units disperse light through a light guide plate from fluorescent lamps arranged on the periphery of a flat panel to the overall surface of the panel. The edge-type back light units have low luminance and unsuitability for large-screen liquid crystal displays, as compared to direct-type back light units.

Direct-type back light units utilize fluorescent lamps arranged under a diffusion plate in a row and directly emit light throughout fluorescent lamps, thus advantageously exhibiting improved optical efficiency and suitability for large-screens, as compared to edge-type back light back light units. However, in such a back light unit, the shape of the fluorescent lamps may be visible on liquid crystal display panels. To prevent this phenomenon, the area provided between fluorescent lamps and diffusion plates should be sufficiently secured, and a diffusion agent inevitably added to the diffusion plate to realize uniform light distribution causes an increase in the overall thickness of the back light unit, thus disadvantageously limiting slimness.

### SUMMARY OF THE INVENTION

Accordingly, the present invention is directed to a liquid crystal display device and a method for fabricating the same that substantially obviate one or more problems due to limitations and disadvantages of the related art.

It is one object of the present invention to separately operate LED back light units and thereby improve luminance and realize slimness of the back light units.

It is another object of the present invention to manufacture independent LED blocks commonly applicable, regardless of the model size of liquid crystal display devices and thereby reduce manufacturing costs and time of back light units.

To achieve these objects and other advantages and in accordance with the purpose of the invention, as embodied and broadly described herein, provided is a liquid crystal display device including: a liquid crystal display panel; and a back light unit comprising a plurality of LED local blocks arranged in a matrix, each having a same. In accordance with another aspect, provided is a method for fabricating a liquid crystal display device including: forming a liquid crystal display panel; and fabricating a back light unit comprising a plurality of LED local blocks arranged in a matrix, each having same size, wherein the step of fabricating the back light unit includes: varying the numbers of columns and rows of the LED local blocks to form a back light unit selectively applicable to the liquid crystal display panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and along with the description serve to explain the principle of the invention. In the drawings:

FIG. 1 is an exploded perspective view illustrating a liquid crystal display device according to one embodiment of the present invention;

FIG. 2 is a perspective view illustrating one LED local block of the liquid crystal display device shown in FIG. 1;

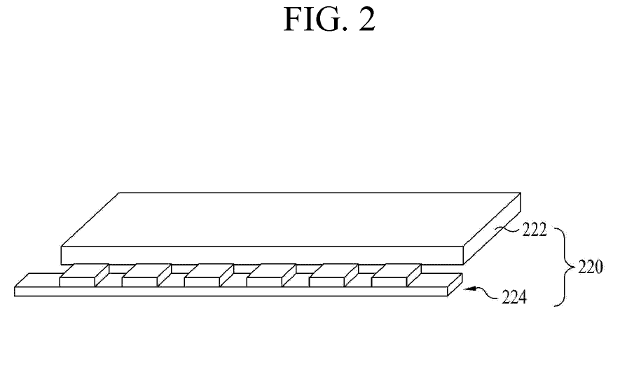

FIG. 3 is a view illustrating commonly applicable LED local blocks and various sizes of liquid crystal display device models;

FIG. 4 is a view illustrating model sizes of liquid crystal display devices which are mass-produced or will be mass-produced and the size of first LED local blocks applicable thereto;

FIG. 5 is a view illustrating model sizes of liquid crystal display devices which are mass-produced or will be mass-produced and the size of second LED local blocks applicable thereto; and

FIG. 6 is a flow chart schematically illustrating a process for fabricating a back light unit according to the present invention.

### DETAILED DESCRIPTION OF THE INVENTION

Hereinafter, preferred embodiments of the present invention will be described in detail with reference to the accompanying drawings.

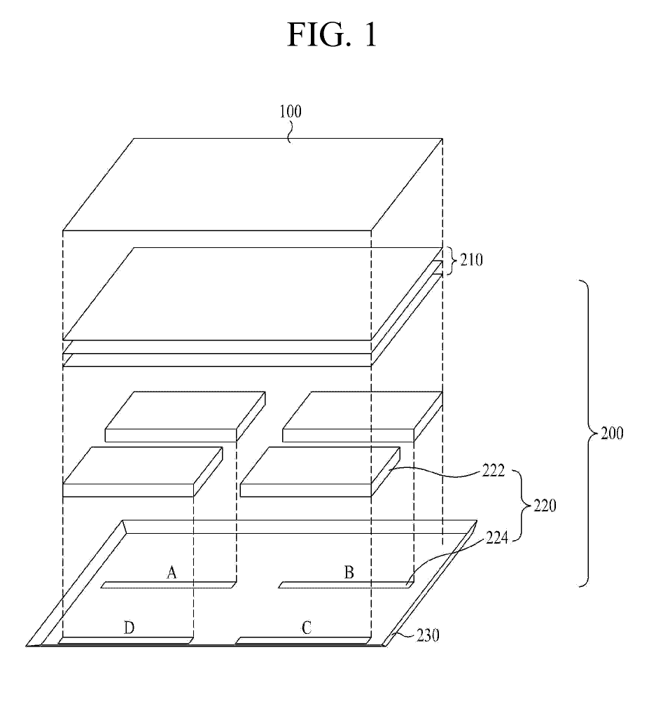

FIG. 1 is an exploded perspective view illustrating a liquid crystal display device according to one embodiment of the present invention.

As shown in FIG. 1, the liquid crystal display device comprises a liquid crystal display panel 100 to display an image and a back light unit 200 to supply light to the liquid crystal display panel 100.

The liquid crystal display panel 100 comprises a thin film transistor array substrate and a color filter array substrate facing each other, and a liquid crystal interposed between the thin film transistor array substrate and the color filter array substrate. The thin film transistor array substrate comprises signal lines and thin film transistors arranged on a lower substrate, and the color filter array substrate comprises a color filter and a black matrix arranged on an upper substrate. The liquid crystal is optically and dielectrically anisotropic, thus rotating according to an electric field to vary an optical transmittance and thereby realize an image.

The back light unit 200 comprises a plurality of LED local blocks 220 to emit light to the liquid crystal display panel 100, a bottom cover 230 in which the LED local blocks 220 and the liquid crystal display panel 100 are accepted, a reflective member (not shown) provided at an inner side or on a bottom surface of the bottom cover 230 to reflect light, and an optical sheet member 210 interposed between the LED local blocks 220 and the liquid crystal display panel 100. An example wherein the inner bottom of the bottom cover 230 is divided into four regions (A, B, C and D) is illustrated in FIG. 1.

The optical sheet member 210 comprises a diffusion sheet to homogeneously diffuse and emit light from the LED local blocks 220 to the liquid crystal display panel 100, a prizm sheet to refract light diffused from the diffusion sheet and emit the same to the liquid crystal display panel 100 and a protective sheet to protect the other sheets, but is not limited to these elements.

The bottom cover 230 accepts the liquid crystal display panel 100, the optical sheet member 210 and the LED local blocks 220 therein.

The reflective member is provided on the inner side or the bottom surface of the bottom cover 230 to reflect light emitted from the LED local blocks 220 and thereby increase optical-utilization efficiency.

The plurality of LED local blocks 220 are arranged in a matrix. The respective LED local blocks 220 are in a plurality of regions to partition an inner region of the bottom cover 230 under the optical sheet member 210. Each LED local block 220 comprises sub-light guide plates 222, and an LED array 224 arranged at one side of each sub light guide plate 222 to emit light to the sub light guide plate 222. The LED array 224 has a structure in which a plurality of LEDs are arranged in series. Based on such a structure, the respective LED local blocks 220 can operate independently. As a result, the back light unit 200 according to the present invention enables separate operation, e.g., independent control over light amount, depending on its position. These partially operable LED local blocks 220 utilize a plurality of light sources, thus exhibiting high luminance, as compared to edge-type light sources and eliminating the necessity for sufficient area between lamps and the diffusion plate required for direct-type lamps, thereby realizing slimness of the overall thickness of the back light unit. In addition, the LED local blocks 220 provide light to the desired regions, thus contributing to improvement in image quality.

Meanwhile, the back light unit 200 comprises the LED local blocks 220 which are independently separately operatable and have a size commonly applicable to liquid crystal display panels 100 having different sizes. That is, the back light unit 200 according to the present invention is selectively applied to the liquid crystal display panels 100 having different sizes by varying the number of columns and rows of the LED local blocks 220 arranged in the matrix.

More specifically, the back light unit 200 is separately fabricated, depending on the model size of liquid crystal display devices. For example, to manufacture 32-inch model of liquid crystal display device, the back light unit corresponding to the 32-inch model is fabricated. That is, as shown in FIG. 1, to fabricate the back light unit 200 enabling separate operation, the total planar area of four LED local blocks 220 should be approximately equivalent to the area of the liquid crystal display panel 100. Accordingly, when the model of the liquid crystal display device is changed, LED local blocks 220 suited to the corresponding model should be manufactured, thus entailing considerably low economic efficiency.

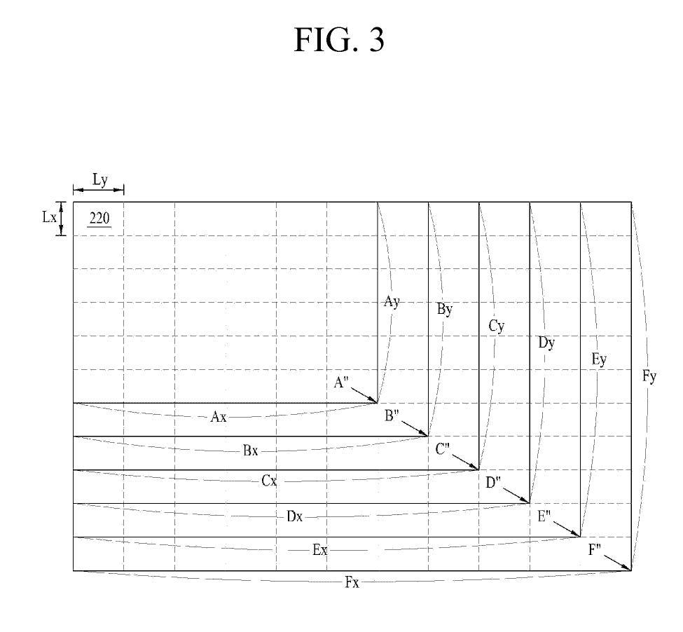

Hereinafter, LED local blocks 220 applicable regardless of the model size of the liquid crystal display devices, the back light unit flexibly applicable depending on the arrangement of the LED local blocks 220, a liquid crystal display device comprising the same and a method for fabricating the same will be described with reference to FIG. 3 below.

First, an optical sheet member 210 and a bottom cover 230 suitable for the model of the liquid crystal display devices are provided. In addition, the plurality of LED local blocks 220 each having same size are fabricated.

FIG. 3 shows different model sizes of liquid crystal display devices. A″, B″, C″, D″, E″ and F″ indicate A-inch, B-inch, C-inch, D-inch, E-inch and F-inch, the sizes of liquid crystal display devices, respectively, Ax, Bx, Cx, Dx, Ex and Fx indicate A-inch, B-inch, C-inch, D-inch, E-inch, and F-inch, widths of liquid crystal display devices, respectively, and Ay, By, Cy, Dy, Ey and Fy indicate A-inch, B-inch, C-inch, D-inch, E-inch and F-inch, lengths of liquid crystal display devices, respectively. Lx and Ly indicate the width and length of LED local blocks 220, respectively.

As shown in FIG. 3, the width of LED local blocks 220 (Lx) is determined such that Ax, Bx, Cx, Dx, Ex and Fx are equivalent to k-times of the width of LED local blocks 220 (Lx) (k is a natural number determined by the size of the liquid crystal display device), and the length of LED local blocks 220 is determined such that Ay, By, Cy, Dy, Ey and Fy are equivalent to m-times of the length (Ly) of LED local blocks 220 (m is a natural number determined by the size of the liquid crystal display device). As a result, A-inch, B-inch, C-inch, D-inch, E-inch and F-inch liquid crystal display devices can be manufactured by decreasing the number of LED local blocks 220 without separately manufacturing back light units. That is, a plurality of LED local blocks having a size applicable to all models of liquid crystal display devices are manufactured and are arranged in the form of a matrix made up of a plurality of columns and rows suited to the liquid crystal display panel 100 having a predetermined size to complete manufacture of the back light unit 200. By varying the numbers of the columns and rows of the LED local blocks 220 arranged in the matrix, the back light unit applicable to the liquid crystal display panels having different sizes can be obtained.

As a result, the necessity of manufacturing a sub-light guide plate 222 and an LED array 224 specific to each model of liquid crystal display device is eliminated and manufacturing costs of the back light unit 200 can be significantly reduced.

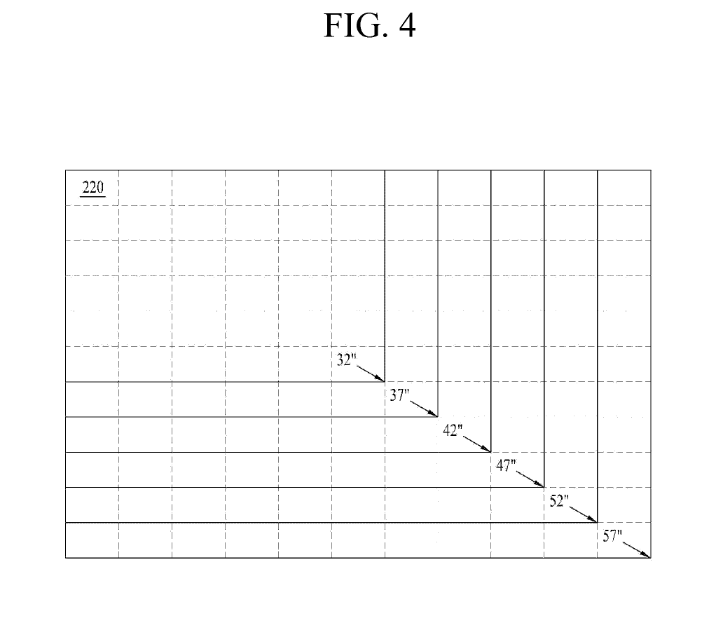

FIG. 4 shows models of liquid crystal display devices which are mass-produced or will be mass-produced and the size of LED local blocks 220 applicable thereto.

Referring to FIG. 4, in the case of 32-inch (32″) liquid crystal display device, 36 LED local blocks 220 (6 columns×6 rows) having a width of 117.9 to 119.9 mm and a length of 66.7 to 68.7 mm are used to manufacture the back light unit. In the same manner, 49 LED local blocks 220 (7 columns×7 rows) are used for the 37-inch (37″) liquid crystal display device, 64 LED local blocks 220 (8 columns×8 rows) are used for the 42-inch (42″) liquid crystal display device, 47 LED local blocks 220 (9 columns×9 rows) are used for the 47-inch (47″) liquid crystal display device, 100 LED local blocks 220 (10 columns×10 rows) are used for the 52-inch (52″) liquid crystal display device, and 121 LED local blocks 220 11 columns×11 rows) are used for the 57-inch (57″) liquid crystal display device.

That is, in the array of LED local blocks 220 for the 32-inch (32″) liquid crystal display device, the number of columns and rows increases by one to manufacture the back light unit 200 for the 37-inch (37″) liquid crystal display device. In the same manner, the back light units for the 42-inch (42″), 47-inch (47″), 52-inch (52″) and 57-inch (57″) liquid crystal display devices can also be manufactured.

Meanwhile, the width of LED local blocks 220, 117.9 to 119.9 mm, is determined such that multiply of the width of the LED local blocks 220 by a predetermined natural number yields the lengths of 32-inch (32″), 37-inch (37″), 42-inch (42″), 47-inch (47″), 52-inch (52″) and 57-inch (57″) liquid crystal display devices. In the same manner, the length of LED local blocks 220, 66.7 to 68.7 mm, is determined such that multiply of the width of the LED local blocks 220 by a predetermined natural number yields the lengths of 32-inch (32″), 37-inch (37″), 42-inch (42″), 47-inch (47″), 52-inch (52″) and 57-inch (57″) liquid crystal display devices.

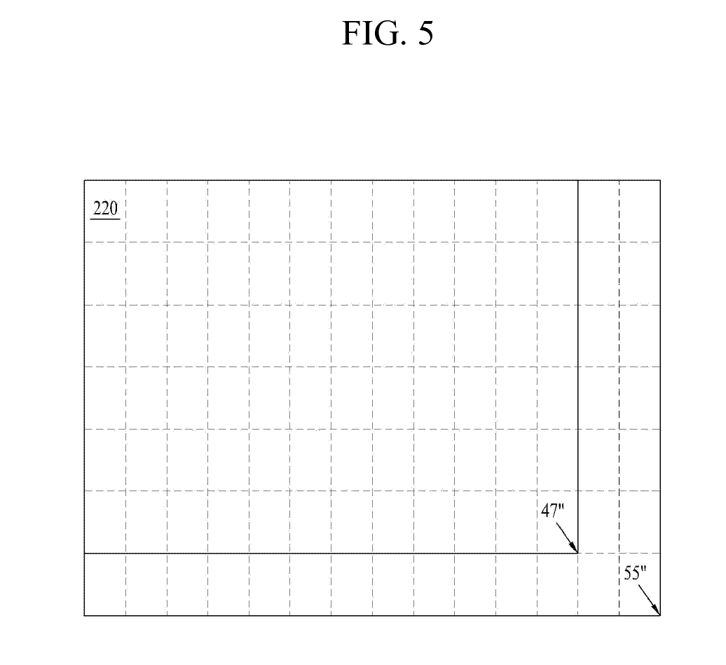

FIG. 5 shows model sizes of liquid crystal display devices which are mass-produced or will be mass-produced and the size of LED local blocks 220 applicable thereto according to another embodiment.

Referring to FIG. 5, in the case of 47-inch (47″) liquid crystal display devices, 72 LED local blocks 220 (6 columns×12 rows) having a width of 86.7 to 88.7 mm and a length of 98.7 to 100.7 mm are used to manufacture the back light unit. In the same manner, 98 LED local blocks 220 (7 columns×14 rows) are used for 55-inch (55″) liquid crystal display devices. In the same manner, by adding one column and two rows to the original columns and rows (6 columns×12 rows) of LED local blocks 220, the back light unit 200 applicable to 55-inch (55″) liquid crystal display devices can be readily manufactured.

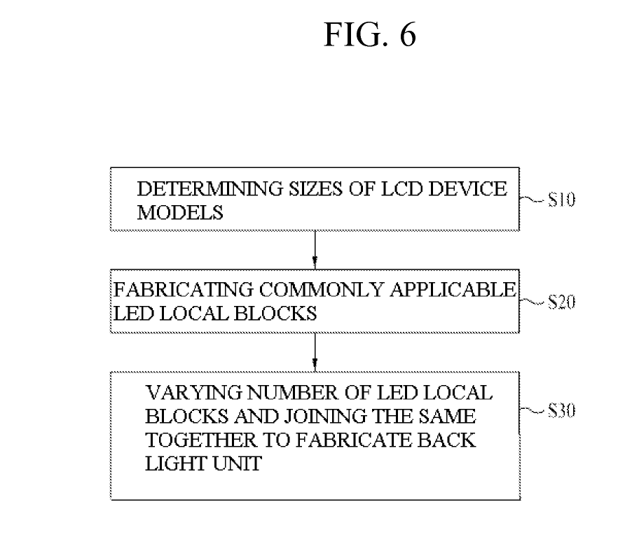

The back light unit of the liquid crystal display device may be simply represented by block diagram in FIG. 6.

In a first step S10, the size (inches) of liquid crystal display devices mass-produced or in the process of designing mass-production is determined.

Then, in a second step S20, LED local blocks having a size commonly applicable to respective liquid crystal display device models are manufactured. The size of LED local blocks is obtained in the manner as described in FIGS. 3 to 5.

Then, in a second step S30, only the number of LED local blocks is varied and the LED local blocks are joined together to fabricate the back light unit corresponding to the inches of respective models.

As such, the liquid crystal display device and the method for fabricating the same according to the present invention involve manufacturing a plurality of LED local blocks 220 having a size commonly applicable to liquid crystal display devices, regardless of the model size thereof, and arranging the LED local blocks 220 in the form of a matrix to manufacture the back light unit 200. The numbers of columns and rows of LED local blocks 220 are varied to complete manufacture of back light units selectively applicable to different sizes of liquid crystal display panels. This enables elimination of the necessity of manufacturing light guide plates and LED arrays of back light units for respective liquid crystal display device model applications, thus advantageously significantly reducing manufacturing costs and time of the back light unit and the overall manufacturing costs and time of liquid crystal display devices.

As apparent from the afore-going, the liquid crystal display device and the method for fabricating the same utilize separately operable LED local blocks, thus enabling high luminance, as compared to edge-type light sources and small overall back light unit thickness, as compared to direct-type lamps.

In addition, the liquid crystal display device and the method for fabricating the same comprise a plurality of LED local blocks having a size commonly applicable to liquid crystal display devices, regardless of the model sizes thereof. Furthermore, by simply joining LED local blocks together depending on the model size, the back light unit can be completely manufactured. As a result, the necessity of manufacturing elements such as light guide plates and LED arrays suitable for all models of back light units is eliminated, manufacturing costs and time of the back light unit are significantly reduced and the overall manufacturing costs of liquid crystal display devices are reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device comprising:
a liquid crystal display panel; and
a back light unit comprising a plurality of LED local blocks arranged in a matrix, each having a same size.

2. The liquid crystal display device according to claim 1, wherein the back light unit further comprises:
an optical sheet member interposed between the plurality of LED local blocks and the liquid crystal display panel;
a bottom cover to accept the optical sheet member and the LED local blocks; and
a reflective member arranged in an inner side or a bottom surface of the bottom cover.

3. The liquid crystal display device according to claim 2, wherein the plurality of LED local blocks are manufactured such that a width of the liquid crystal display panel is equivalent to k-times (wherein k is a natural number determined by a size of the liquid crystal display panel) of a width of each LED local block and a length of the liquid crystal display panel is equivalent to m-times (wherein m is a natural number determined by the size of the liquid crystal display panel) of a length of each LED local block.

4. The liquid crystal display device according to claim 3, wherein each LED local block comprises a sub-light guide plate and an LED array arranged at one side of the sub-light guide plate in series.

5. The liquid crystal display device according to claim 3, wherein the liquid crystal display panel is 32-inch, 37-inch, 42-inch, 47-inch, 52-inch or 57-inch models, and each LED local block has a width of 117.9 to 119.9 mm and a length of 66.7 to 68.7 mm.

6. The liquid crystal display device according to claim 3, wherein the liquid crystal display panel is 47-inch or 55-inch models, and each LED local block has a width of 86.7 to 88.7 mm and a length of 98.7 to 100.7 mm.

7. A method for fabricating a liquid crystal display device comprising:
forming a liquid crystal display panel; and
fabricating a back light unit comprising a plurality of LED local blocks arranged in a matrix, each having same size
wherein the step of fabricating the back light unit comprises:
varying the numbers of columns and rows of the LED local blocks to form a back light unit selectively applicable to the liquid crystal display panel.

8. The method according to claim 6, wherein the step of fabricating the back light unit further comprises:
providing an optical sheet member interposed between the LED local blocks and the liquid crystal display panel;
providing a bottom cover to accept the optical sheet member and LED local blocks; and
providing a reflective member in an inner side or a bottom surface of the bottom cover.

9. The method according to claim 7, wherein the plurality of LED local blocks are manufactured such that a width of the liquid crystal display panel is equivalent to k-times (wherein k is a natural number determined by a size of the liquid crystal display panel) of a width of each LED local block and a length of liquid crystal display panel is equivalent to m-times (wherein m is a natural number determined by the size of the liquid crystal display panel) of a length of each LED local block.

10. The method according to claim 7, wherein each LED local block comprises a sub-light guide plate and an LED array arranged at one side of the sub-light guide plate in series.
